(19) United States
(12) Patent Application Publication
(10) Pub. No.: US 2025/0076559 A1
(43) Pub. Date: Mar. 6, 2025

(54) EMBEDDED FILMS FOR WAVEGUIDE COMBINERS

(71) Applicant: Applied Materials, Inc., Santa Clara, CA (US)

(72) Inventors: Kevin MESSER, Mountain View, CA (US); Evan WANG, Palo Alto, CA (US)

(21) Appl. No.: 18/823,373

(22) Filed: Sep. 3, 2024

Related U.S. Application Data
(60) Provisional application No. 63/580,564, filed on Sep. 5, 2023.

(51) Int. Cl. F21V 8/00; G02B 27/00

(52) U.S. Cl. CPC G02B 6/0026; G02B 6/002; G02B 6/0065; G02B 6/0076; G02B 27/0081

(57) ABSTRACT

A waveguide combiner including a first substrate, a second substrate, and a wavelength selective film, wherein the wavelength selective film is disposed between the first substrate and the second substrate, the wavelength selective film is operable to reflect a red light, refract and transmit a blue light, and refract and transmit a green light.

### CROSS-REFERENCE TO RELATED APPLICATIONS

This application claims benefit of U.S. provisional patent application Ser. No. 63/580,564, filed Sep. 5, 2023, which is herein incorporated by reference.

### BACKGROUND

### Field

Embodiments of the present disclosure generally relate to waveguide combiners. More specifically, embodiments described herein provide for waveguide combiners having embedded films.

### Description of the Related Art

Virtual reality is generally considered to be a computer generated simulated environment in which a user has an apparent physical presence. A virtual reality experience can be generated in 3D and viewed with a head-mounted display (HMD), such as glasses or other wearable display devices that have near-eye display panels as lenses to display a virtual reality environment that replaces an actual environment.

Augmented reality, however, enables an experience in which a user can still see through the display lenses of the glasses or other HMD device to view the surrounding environment, yet also see images of virtual objects that are generated for display and appear as part of the environment. Augmented reality can include any type of input, such as audio and haptic inputs, as well as virtual images, graphics, and video that enhances or augments the environment that the user experiences. As an emerging technology, there are many challenges and design constraints with augmented reality.

One such challenge is displaying a virtual image overlaid on an ambient environment. Waveguide combiners are used to assist in overlaying images. Generated light is in-coupled into a waveguide combiner, propagated through the augmented waveguide combiner, out-coupled from the augmented waveguide combiner, and overlaid on the ambient environment. Light is coupled into and out of augmented waveguide combiners using surface relief gratings.

However, conventional surface relief gratings suffer from significant color non-uniformity. One reason for this color non-uniformity is that the density of interactions with the grating surfaces is significantly lower for longer wavelengths of light than shorter wavelengths of light due to the dispersion of diffracted angles of propagation inside the underlying substrate. Even further, shallow surface relief gratings have higher diffraction efficiency for shorter wavelengths as compared to longer wavelengths, which exacerbates the variance in interaction density between wavelengths.

Current solutions to the aforementioned challenges include the incorporation of a semi-reflective layer in waveguide combiners, and/or the bonding of a lower index substrates to the backsides of higher index substrates. However, semi-reflective layers do not exhibit strong angular selectivity and wavelength selectivity, and thereby do not fully address the issue of color non-uniformity for waveguide combiners designed to support multiple display color channels. And, the transition between angles that can and cannot propagate in a lower index substrate bonded to a higher index substrate are very sharp in angle in the field-of-view of a user, which leads to undesirable non-uniformity in the viewed image.

Accordingly, what is needed in the art are improved structures for waveguide combiners.

### SUMMARY

Certain embodiments herein provide a waveguide combiner, including a first substrate, a second substrate, and a wavelength selective film. The first substrate includes a structure surface and a first film surface opposing the structure surface, a first refractive index (RI), and surface relief structures disposed over the structure surface. The second substrate includes a second film surface, a second RI, and a reflective surface opposing the second film surface. A wavelength selective film is between the first film surface and the second film surface. The wavelength selective film has a film RI. The film RI is less than the first RI and the second RI. A film thickness of the wavelength selective film is about 1 nanometer (nm) to about 10 micrometers (μm). The wavelength selective film is operable to reflect a red light, refract a blue light though the wavelength selective film and transmit the blue light to the first substrate and the second substrate, and refract a green light though the wavelength selective film and transmit the green light to the first substrate and the second substrate.

Certain embodiments herein provide a waveguide combiner, including a first substrate, a second substrate, a wavelength selective film, and a local thickness adjustment layer (LTAL). The first substrate includes a structure surface, a first film surface opposing the structure surface, and surface relief structures disposed over the structure surface. The second substrate includes a second film surface, and a reflective surface opposing the second film surface. The wavelength selective film is between the first film surface and the second film surface, and the local thickness adjustment layer (LTAL) is disposed over the reflective surface. The LTAL has a target substrate thickness distribution varying over the reflective surface.

Certain embodiments herein provide a method of projecting an image with improved color uniformity. The method includes incoupling a light to a waveguide combiner. The light comprises at least three input wavelengths, the at least three input wavelengths comprising a blue light, a green light, and a red light, and the waveguide combiner comprises a structure surface, a first substrate, a second substrate comprising a reflective surface, and a wavelength selective film disposed between the first substrate and the second substrate. The method further includes reflecting the red light with the wavelength selective film to the structure surface, refracting the blue light though the wavelength selective film and transmitting the blue light to the first substrate and the second substrate, and refracting green light though the wavelength selective film and transmitting the green light to the first substrate and the second substrate. Thereafter, the method includes outcoupling the light from the waveguide combiner.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate exemplary embodiments and are therefore not to be considered limiting of its scope, and may admit to other equally effective embodiments.

FIG. 1 is a cross sectional view of a waveguide combiner according to embodiments described herein.

FIG. 2A-2C are cross sectional views of a waveguide combiner according to embodiments described herein.

FIG. 3 is a cross sectional view of a waveguide combiner according to embodiments described herein.

FIG. 4 is a perspective front view of a waveguide combiner according to embodiments described herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to waveguide combiners. More specifically, embodiments described herein provide for waveguide combiners having embedded films to address the challenges of color non-uniformity of conventional waveguides.

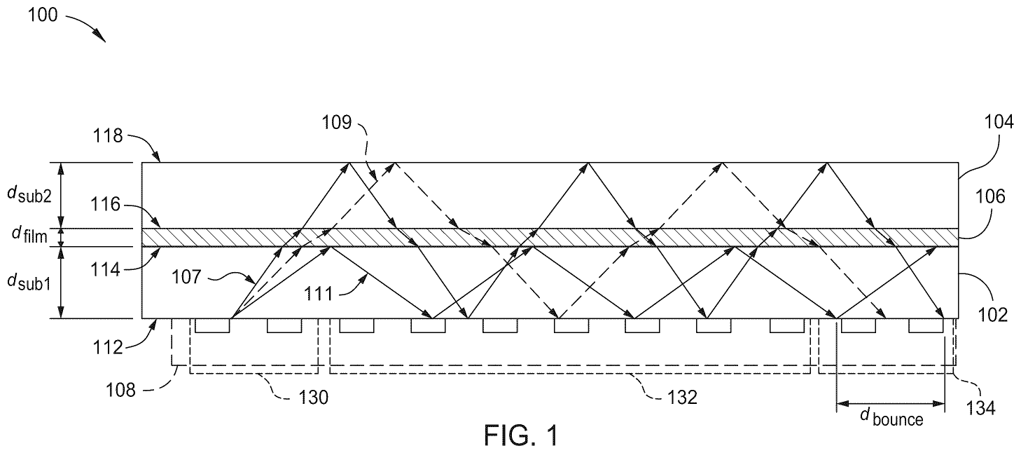

FIG. 1 is a cross sectional view of a waveguide combiner 100 facilitating projection of images with improved color uniformity. The waveguide combiner 100 includes at least one of a first substrate 102, a second substrate 104, and a wavelength selective film 106. The first substrate 102 includes a structure surface 112 and a first film surface 114 opposing the structure surface 112. The second substrate 104 includes a second film surface 116 and a reflective surface 118 opposing the second film surface 116.

The first substrate 102 and/or the second substrate 104 can be any substrate used in the art, and can be either opaque or transparent to a chosen wavelength of light, depending on the use of the first substrate 102 and/or second substrate 104 as a substrate for a waveguide combiner. Substrate selection may include substrates of any suitable material, including, but not limited to, amorphous dielectrics, non-amorphous dielectrics, crystalline dielectrics, polymers, or combinations thereof. In some embodiments, the first substrate 102 and/or second substrate 104 includes, but is not limited to, a silicon-containing material, a silicon and oxygen containing compound, a germanium-containing material, a indium and phosphide containing compound, a gallium and arsenic containing compound, a gallium and nitrogen containing compound, a carbon-containing material, a silicon and carbon containing compound, a silicon, carbon, and oxygen containing compound, a silicon and nitrogen containing compound, a silicon, oxygen, and nitrogen containing compound, a niobium and oxygen containing compound, and lithium, niobium, and oxygen containing compound, an aluminum and oxygen containing compound, a indium, tin, and oxygen containing compound, a titanium and oxygen containing compound, a lanthanum and oxygen containing compound, a gadolinium and oxygen containing compound, a zinc and oxygen containing compound, a yttrium and oxygen containing compound, a tungsten and oxygen containing compound, a potassium, and oxygen containing compound, a phosphorous and oxygen containing compound, a barium and oxygen containing compound, a sodium and oxygen containing compound, or combinations thereof. In other embodiments, which can be combined with other embodiments described herein, the first substrate 102 and/or second substrate 104 includes an oxide including one or more of gadolinium, silicon, sodium, barium, potassium, tungsten, phosphorus, zinc, calcium, titanium, tantalum, niobium, lanthanum, zirconium, lithium, or yttrium containing-materials. Example materials of the substrate 102 and/or 104 include silicon (Si), silicon monoxide (SiO), silicon dioxide (SiO₂), silicon carbide (SiC), fused silica, diamond, quartz germanium (Ge), silicon germanium (SiGe), indium phosphide (InP), gallium arsenide (GaAs), gallium nitride (GaN), sapphire, sapphire (Al₂O₃), lithium niobate (LiNbO₃), indium tin oxide (ITO), lanthanum oxide (La₂O₃), gadolinium oxide (Gd₂O₅), zinc oxide (ZnO), yttrium oxide (Y₂O₃), tungsten oxide (WO₃), titanium oxide (TiO₂), zirconium oxide (ZrO₃), sodium oxide (Na₂O), niobium oxide (Nb₂O₅), barium oxide (BaO), potassium oxide (K₂O), phosphorus pentoxide (P₂O₅), calcium oxide (CaO), or combinations thereof. In some embodiments, the first substrate 102 and the second substrate 104 are formed of the same material(s). In some other embodiments, the first substrate 102 and the second substrate 104 are formed of different material(s).

In some embodiments, the first substrate 102 includes a first material having a first refractive index (RI). In some embodiments, the first RI is about 1.3 to about 3.5 at a wavelength in the visible light spectrum (e.g., about 380 nm to about 700 nm, such as about 635 nm). For example, in some embodiments, the first RI is about 1.4 about 3.4, or about 1.5 to about 3.3, or about 1.6 to about 3.2, or about 1.7 to about 3.1, or about 1.8 to about 3.0, or about 1.9 to about 2.9, or about 2.0 to about 2.8, or about 2.1 to about 2.7, or about 2.2 to about 2.6, or about 2.3 to about 2.5, at a visible light wavelength. In some embodiments, the first RI is about 1.5 to about 2.7 at a visible light wavelength.

In some embodiments, the second substrate 104 includes a second material having a second RI. In some embodiments, the second RI is greater than the first RI at a visible wavelength. In some embodiments, the second RI is greater than the first RI minus about 0.2 to about 0.5 at a visible light wavelength. For example, in some embodiments, second RI is greater than the first RI minus about 0.3 or about 0.4 at a visible light wavelength.

The first substrate 102 has a first thickness d_{sub1} from the structure surface 112 to the first film surface 114 opposing the structure surface 112. The second substrate 104 has a second thickness d_{sub2} from the second film surface 116 to the reflective surface 118 opposing the second film surface 116. In some embodiments, the first thickness d_{sub1} and the second thickness d_{sub2} are independently or collectively about 25 micrometers (μm) or greater. For example, in some embodiments, the first thickness d_{sub1} and the second thickness d_{sub2} are independently or collectively about 50 μm or greater. In some embodiments, the first thickness d_{sub1} and the second thickness d_{sub2} are independently or collectively about 75 μm or greater.

The waveguide combiner 100 includes surface relief structures (SRS) 108 disposed on the structure surface 112 of the first substrate 102. The waveguide combiner 100 includes one or more of an in-coupling region (ICR) 130, a pupil expander (PE) 132, or an out-coupling region (OCR) 134 of the SRS 108. In certain embodiments, the SRS 108 can have different dimensions in at least two of the ICR 130, the PE 132, and the OCR 134. In certain embodiments, the SRS 108 can have the same or similar dimensions in at least two of the ICR 130, the PE 132, and the OCR 134.

In some embodiments, the SRS 108 and the first substrate 102 are formed of different material(s). For example, in some embodiments, the SRS 108 include, but are not limited to, one or more oxides, carbides, or nitrides of silicon, aluminum, zirconium, tin, tantalum, zirconium, barium, titanium, hafnium, lithium, lanthanum, cadmium, niobium, or combinations thereof. Example materials of the SRS 108 include silicon carbide, silicon oxycarbide, titanium oxide, silicon oxide, vanadium oxide, aluminum oxide, aluminum-doped zinc oxide, indium tin oxide, tin oxide, zinc oxide, tantalum oxide, silicon nitride, zirconium oxide, niobium oxide, cadmium stannate, silicon oxynitride, barium titanate, diamond like carbon, hafnium oxide, lithium niobate, silicon carbon-nitride, silver, gold, cadmium selenide, mercury telluride, zinc selenide, silver-indium-gallium-sulfur, silver-indium-sulfur, indium phosphide, gallium phosphide, lead sulfide, lead selenide, zinc sulfide, molybdenum sulfide, tungsten sulfide, or combinations thereof.

The wavelength selective film 106 is disposed between the first film surface 114 and the second film surface 116. In some embodiments, the wavelength selective film 106 contacts the first film surface 114 and the second film surface 116. The wavelength selective film 106 has a film thickness d_{film} from first film surface 114 to the second film surface 116. In some embodiments, the film thickness d_{film} is about 1 nm to about 10 μm. For example, in some embodiments, the film thickness d_{film} is about 1 nm to about 9 μm, or about 1 nm to about 8 μm, or about 1 nm to about 7 μm, or about 1 nm to about 6 μm, or about 1 nm to about 5 μm, or about 1 nm to about 4 μm, or about 1 nm to about 3 μm, or about 1 nm to about 2 μm, or about 1 nm to about 1 μm, or about 1 nm to about 0.5 μm. In some embodiments, the film thickness d_{film} is about 25 nm to about 4 μm, such as about 50 nm to about 3 μm.

The wavelength selective film 106 has a film RI. In some embodiments, the film RI is less than the first RI and the second RI. In some embodiments, the film RI is about 1.1, about 1.2, or about 1.3 to less than the first RI at a visible light wavelength. For example, in certain embodiments, the film RI is about 1.4 to less than the first RI at a visible light wavelength. In some embodiments, the film RI is less than the first RI.

The wavelength selective film 106 includes, but is not limited to, amorphous dielectrics, non-amorphous dielectrics, crystalline dielectrics, silicon oxides, metals, alloys, polymers, organic resist materials, nanoparticle doped resist materials, optical adhesives, or combinations thereof. For example, the wavelength selective film 106 includes, but is not limited to, silicon dioxide (SiO₂), titanium monoxide (TiO), titanium dioxide (TiO₂), niobium monoxide (NbO), niobium dioxide (NbO₂), niobium pentoxide (Nb₂O₅), hafnium dioxide (HfO₂), tantalum pentoxide (Ta₂O₅), dilanthanum dititanium heptaoxide (La₂Ti₂O₇), aluminum oxide (Al₂O₃), zirconium dioxide (ZrO₂), magnesium difluoride (MgF₂), cerium trifluoride (CeF₃), silicon nitride (Si₃N₄), or combinations thereof.

Light coupled into the waveguide combiner 100 includes three input wavelengths: a blue light 107, a green light 109, and a red light 111. The light is in-coupled by the ICR 130. The blue light 107 has a wavelength of about 380 nm to about 495 nm, the green light 109 has a wavelength of about 495 nm to about 590 nm, and the red light 111 has a wavelength of about 590 nm to about 750 nm.

The wavelength selective film 106 is operable to reflect the red light 111. The red light 111 is reflected from wavelength selective film 106 to the structure surface 112 of the first substrate 102. The wavelength selective film 106 is operable to refract the blue light 107 from the structure surface 112 through the wavelength selective film 106 and further transmit the blue light 107 to the reflective surface 118 of the second substrate 104. The blue light 107 reflecting from the reflective surface 118 of the second substrate 104 is refracted through the wavelength selective film 106 and transmitted to the structure surface 112 of the first substrate 102. The wavelength selective film 106 is operable to refract the green light 109 from the structure surface 112 through the wavelength selective film 106 and transmit the green light 109 to the reflective surface 118 of the second substrate 104. The green light 109 reflecting from the reflective surface 118 of the second substrate 104 is refracted through the wavelength selective film 106 and transmitted to the structure surface 112 of the first substrate 102.

The wavelength selective film 106 described herein is disposed between the first substrate 102 and the second substrate 104 and provides for reflection of red light 111 having wavelengths with shorter bounce spacing, and diffraction and transmission of blue light 107 and green light 109 having larger bounce spacing. The reflection of red light 111 and the transmission of blue light 107 and green light 109 undergoing TIR through the waveguide combiner 100 provides for a bounce spacing (d_{bounce}) between the red light 111, blue light 107, and green light 109 at the OCR 134 allowing for a projected image from the OCR 134 with improved color uniformity. The film RI and the film thickness d_{film} of the wavelength selective film 106 relative to the first RI and the first thickness d_{sub1} of the first substrate 102, as well as the second RI and second thickness d_{sub2} of the second substrate 104, as described herein, result in the d_{bounce} to project an image with improved color uniformity.

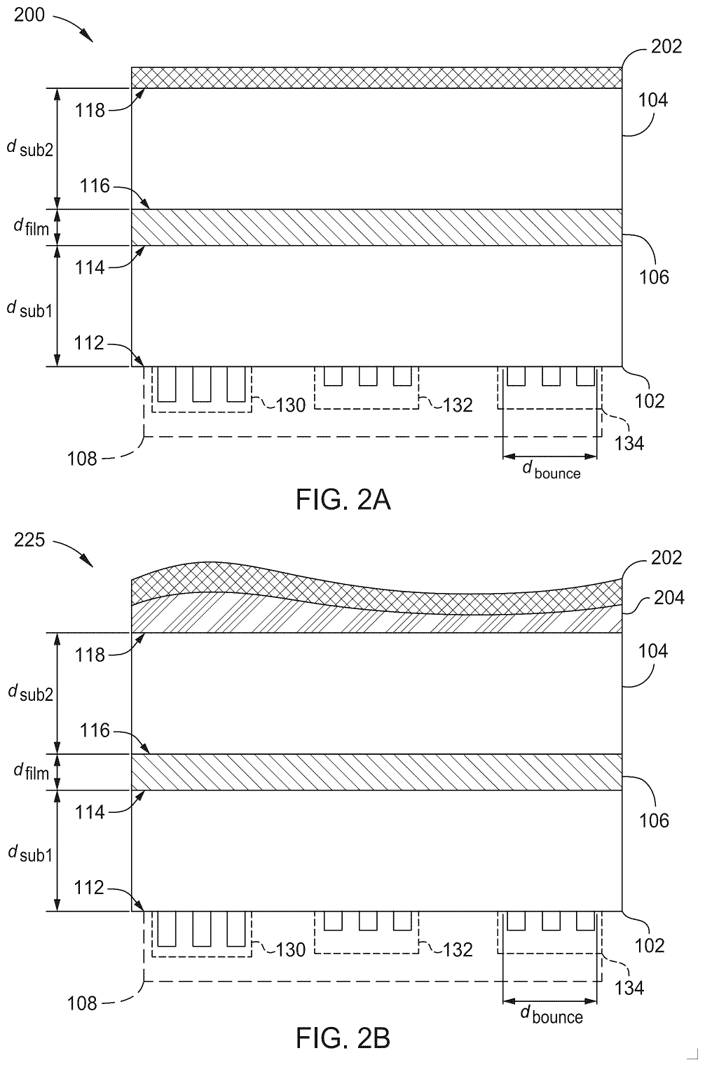

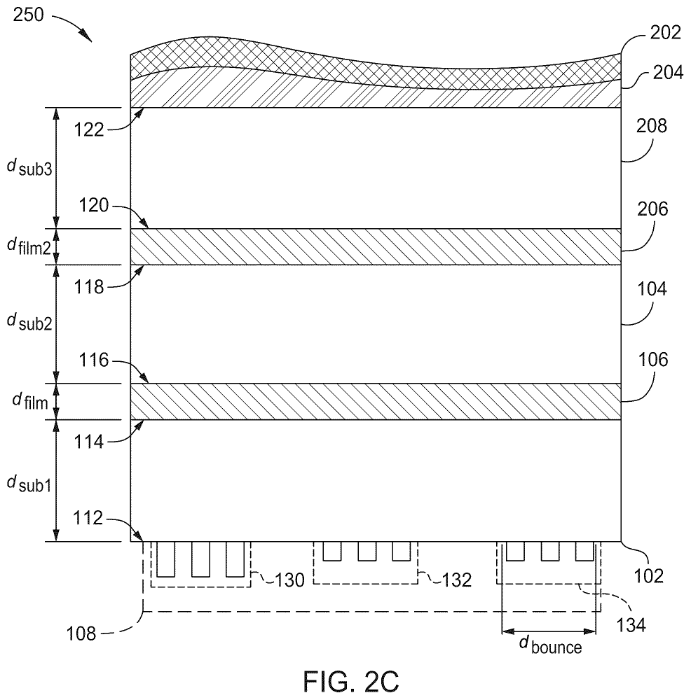

FIG. 2A is a cross sectional view of a waveguide combiner 200 facilitating projection of images with improved color uniformity. The waveguide combiner 200 includes the first substrate 102, the second substrate 104, and the wavelength selective film 106. The first substrate 102 includes a structure surface 112 and a first film surface opposing the structure surface 112. The second substrate 104 includes a second film surface 116 and a reflective surface 118 opposing the second film surface 116.

The waveguide combiner 200 includes the SRS 108 disposed on the structure surface 112 of the first substrate 102. The waveguide combiner 200 includes one or more of the ICR 130, the PE 132, or the OCR 134 of the SRS 108.

An anti-reflection coating 202 is disposed on the reflective surface 118 of the second substrate 104 to prevent unwanted reflections from the environment external to the waveguide combiner 200. The anti-reflection coating 202 includes one or more layers. Each layer of the anti-reflection coating 202 includes, but not is not limited to, amorphous dielectrics, non-amorphous dielectrics, crystalline dielectrics, silicon oxides, metals, alloys, polymers, organic resist materials, nanoparticle doped resist materials, optical adhesives, or combinations thereof. For example, each layer of the anti-reflection coating 202 includes, but not is not limited to, SiO₂, titanium monoxide (TiO), titanium dioxide (TiO₂), niobium monoxide (NbO), niobium dioxide (NbO₂), niobium pentoxide (Nb₂O₅), hafnium dioxide (HfO₂), tantalum pentoxide (Ta₂O₅), dilanthanum dititanium heptaoxide (La₂Ti₂O₇), aluminum oxide (Al₂O₃), zirconium dioxide (ZrO₂), magnesium difluoride (MgF₂), cerium trifluoride (CeF₃), silicon nitride (Si₃N₄), or combinations thereof. In some embodiments, one or more layers of the anti-reflection coating 202 are formed of the same material. In some embodiments, one or more layers of the anti-reflection coating 202 are formed of a different material. In some embodiments, the one or more layers of the anti-reflection coating 202 are collectively between about 10 nm and about 1000 nm in thickness, such as between about 100 nm and about 900 nm, or between about 200 nm and about 800 nm, or between about 300 nm and about 700 nm, or between about 400 nm and about 600 nm, or about 500 nm.

FIG. 2B is a cross sectional view of a waveguide combiner 225 facilitating projection of images with improved color uniformity. The waveguide combiner 225 includes of the first substrate 102, the second substrate 104, and the wavelength selective film 106. The first substrate 102 includes the structure surface 112 and the first film surface opposing the structure surface 112. The second substrate 104 includes the second film surface 116 and the reflective surface 118 opposing the second film surface 116.

The waveguide combiner 225 includes the SRS 108 disposed on the structure surface 112 of the first substrate 102. The waveguide combiner 225 includes one or more of the ICR 130, the PE 132, or the OCR 134 of the SRS 108.

A local thickness adjustment layer (LTAL) 204 is disposed over the reflective surface (e.g., reflective surface 118 of the second substrate 104) to achieve a target substrate thickness distribution, or variation. In other embodiments, the LTAL 204 is disposed over the topmost substrate surface. In some embodiments, the LTAL 204 is disposed between the structure surface 112 of the first substrate 102 and the SRS 108. Generally, the LTAL 204 can function to achieve a target local thickness variation (LTV) or even a target total thickness variation (TTV) over the reflective surface 118, which can be beneficial in optimizing the performance of the waveguide combiner 225. As light travels through the waveguide combiner 225 by total internal reflection, variations in the thickness of the various layers will alter the light propagation path. This can be detrimental to projected image quality and can cause field distortions, image blurring, and sharpness loss. Thus, by controlling the thickness of the waveguide combiner 225 at target locations, such defects in image quality can be reduced or eliminated.

The LTAL 204 may have a local thickness adjustment layer thickness in the range of about 0.1 nm to about 5 nm, such as between about 0.5 nm to about 4 nm, or between about 1 nm to about 3 nm. In some embodiments, the LTAL (204) may have a thickness greater than about 5 nm. Generally the LTAL 204 may be sized and varied to provide a target thickness distribution for optimal device performance, and to mitigate for thickness deviations that can negatively impact performance metrics such as efficiency, uniformity, and sharpness (MTF). In some embodiments, the LTAL has refractive index within about ±0.2 of the refractive index of an adjacent substrate at a visible light wavelength. Generally, the LTAL 204 may be sized to provide an optimal thickness distribution for device

In some embodiments, the LTAL 204 is formed of any suitable materials, provided that the LTAL 204 can adequately transmit light in a desired wavelength, or wavelength range, and with desired light propagation characteristics. In some embodiments, the LTAL 204 is formed of amorphous dielectrics, non-amorphous dielectrics, crystalline dielectrics, silicon oxide, polymers, or combinations thereof. In some embodiments, the LTAL 204 is formed of a transparent material. In some embodiments, the LTAL 204 is formed of at least one of silicon (Si), silicon dioxide (SiO2), fused silica, quartz, silicon carbide (SiC), germanium (Ge), silicon germanium (SiGe), indium phosphide (InP), gallium arsenide (GaAs), gallium nitride (GaN), sapphire, or combinations thereof.

The anti-reflection coating 202 is disposed over the reflective surface (e.g., reflective surface 118 of the second substrate 104 over the LTAL 204). The anti-reflection coating 202 includes one or more layers. Each layer of the anti-reflection coating 202 includes, but not is not limited to, amorphous dielectrics, non-amorphous dielectrics, crystalline dielectrics, silicon oxides, metals, alloys, polymers, organic resist materials, nanoparticle doped resist materials, optical adhesives or combinations thereof. For example, each layer of the anti-reflection coating 202 includes, but is not limited to, SiO₂, titanium monoxide (TiO), titanium dioxide (TiO₂), niobium monoxide (NbO), niobium dioxide (NbO₂), niobium pentoxide (Nb₂O₅), hafnium dioxide (HfO₂), tantalum pentoxide (Ta₂O₅), dilanthanum dititanium heptaoxide (La₂Ti₂O₇), aluminum oxide (Al₂O₃), zirconium dioxide (ZrO₂), magnesium difluoride (MgF₂), cerium trifluoride (CeF₃), silicon nitride (Si₃N₄), or combinations thereof. In some embodiments, one or more layers of the anti-reflection coating 202 are formed of the same material. In some embodiments, one or more layers of the anti-reflection coating 202 are formed of a different material.

FIG. 2C is a cross sectional view of a waveguide combiner 250 facilitating projection of images with improved color uniformity. The waveguide combiner 250 includes the first substrate 102, the second substrate 104, a third substrate 208, the wavelength selective film 106, and a second wavelength selective film 206. The first substrate 102 includes the structure surface 112 and the first film surface opposing the structure surface 112. The second substrate 104 includes the second film surface 116 and the reflective surface 118 opposing the second film surface 116. The third substrate 208 includes a third film surface 120 and a third reflective surface 122 opposing the third film surface 120.

The third substrate 208 includes a third material having a third RI. In some embodiments, the third RI is greater than the second RI at a visible light wavelength. In some embodiments, the third RI is greater than the second RI minus about 0.2 to about 0.5 at a visible light wavelength. For example, in some embodiments, third RI is greater than the second RI minus about 0.3 or about 0.4 at a visible light wavelength.

The third material includes, but is not limited to, amorphous dielectrics, non-amorphous dielectrics, crystalline dielectrics, silicon oxides, polymers, or combinations thereof. For example, the third material, includes, but is not limited to, a silicon-containing material, a silicon and oxygen containing compound, a germanium-containing material, a indium and phosphide containing compound, a gallium and arsenic containing compound, a gallium and nitrogen containing compound, a carbon-containing material, a silicon and carbon containing compound, a silicon, carbon, and oxygen containing compound, a silicon and nitrogen containing compound, a silicon, oxygen, and nitrogen containing compound, a niobium and oxygen containing compound, and lithium, niobium, and oxygen containing compound, an aluminum and oxygen containing compound, a indium, tin, and oxygen containing compound, a titanium and oxygen containing compound, a lanthanum and oxygen containing compound, a gadolinium and oxygen containing compound, a zinc and oxygen containing compound, a yttrium and oxygen containing compound, a tungsten and oxygen containing compound, a potassium, and oxygen containing compound, a phosphorous and oxygen containing compound, a barium and oxygen containing compound, a sodium and oxygen containing compound, or combinations thereof. In other embodiments, which can be combined with other embodiments described herein, the first substrate 102 and/or second substrate 104 includes an oxide including one or more of gadolinium, silicon, sodium, barium, potassium, tungsten, phosphorus, zinc, calcium, titanium, tantalum, niobium, lanthanum, zirconium, lithium, or yttrium containing-materials. Example materials of the substrate 102 and/or 104 include silicon (Si), silicon monoxide (SiO), silicon dioxide (SiO₂), silicon carbide (SiC), fused silica, diamond, quartz germanium (Ge), silicon germanium (SiGe), indium phosphide (InP), gallium arsenide (GaAs), gallium nitride (GaN), sapphire, sapphire (Al₂O₃), lithium niobate (LiNbO₃), indium tin oxide (ITO), lanthanum oxide (La₂O₃), gadolinium oxide (Gd₂O₅), zinc oxide (ZnO), yttrium oxide (Y₂O₃), tungsten oxide (WO₃), titanium oxide (TiO₂), zirconium oxide (ZrO₃), sodium oxide (Na₂O), niobium oxide (Nb₂O₅), barium oxide (BaO), potassium oxide (K₂O), phosphorus pentoxide (P₂O₅), calcium oxide (CaO), or combinations thereof. In some embodiments, the first substrate 102, the second substrate 104, and or the third substrate 208 are formed of the same material(s). In some embodiments, the first substrate 102, the second substrate 104, and or the third substrate 208 are formed of different material(s).

The third substrate 208 has a third thickness d_{sub3} from the third film surface 120 to the third reflective surface 122 opposing the third film surface 120. In some embodiments, the third thickness d_{sub3} is about 25 μm or greater. In some embodiments, the third thickness d_{sub3} is about 50 μm or greater. In some embodiments, the third thickness d_{sub3} is about 75 μm or greater.

The waveguide combiner 250 includes the SRS 108 disposed on the structure surface 112 of the first substrate 102. The waveguide combiner 250 includes one or more of the ICR 130, the PE 132, or the OCR 134 of the SRS 108.

The second wavelength selective film 206 is disposed between the third film surface 120 of the third substrate 208 and the reflective surface 118 of the second substrate 104. In some embodiments, the second wavelength selective film 206 contacts the third film surface 120 and the reflective surface 118. The wavelength selective film 206 has a second film thickness d_{film2} from the third film surface 120 of the third substrate 208 to the reflective surface 118 of the second substrate 104. In some embodiments, the second film thickness d_{film2} is about 1 nm to about 10 μm. For example, in some embodiments, the film thickness d_{film2} is about 1 nm to about 9 μm, or about 1 nm to about 8 μm, or about 1 nm to about 7 μm, or about 1 nm to about 6 μm, or about 1 nm to about 5 μm, or about 1 nm to about 4 μm, or about 1 nm to about 3 μm, or about 1 nm to about 2 μm, or about 1 nm to about 1 μm, or about 1 nm to about 0.5 μm. In some embodiments, the film thickness d_{film2} is about 25 nm to about 4 μm, such as about 50 nm to about 3 μm.

The second wavelength selective film 206 has a second film RI. In some embodiments, the second film RI is less than the second RI and the third RI. In other embodiments, the second film RI is about 1.1, about 1.2, or about 1.3 to less than the second RI at a visible light wavelength. For example, in certain embodiments, the second film RI is about 1.4 to less than the second RI at a visible light wavelength. The second wavelength selective film 206 includes, but is not limited to, amorphous dielectrics, non-amorphous dielectrics, crystalline dielectrics, silicon oxides, metals, alloys, polymers, organic resist materials, nanoparticle doped resist materials, optical adhesives or combinations thereof. For example, the second wavelength selective film 206 includes, but not is not limited to, SiO₂, titanium monoxide (TiO), titanium dioxide (TiO₂), niobium monoxide (NbO), niobium dioxide (NbO₂), niobium pentoxide (Nb₂O₅), hafnium dioxide (HfO₂), tantalum pentoxide (Ta₂O₅), dilanthanum dititanium heptaoxide (La₂Ti₂O₇), aluminum oxide (Al₂O₃), zirconium dioxide (ZrO₂), magnesium difluoride (MgF₂), cerium trifluoride (CeF₃), silicon nitride (Si₃N₄), or combinations thereof.

The second wavelength selective film 206 is operable to reflect the green light 109. The green light 109 is reflected from the second wavelength selective film 206 to the second film surface 116 of the second substrate 104. The wavelength selective film 106 is operable to refract the green light 109 from the second film surface 116 of the second substrate 104 through the wavelength selective film 106 so that the green light 109 is transmitted to the structure surface 112 of the first substrate 102. The second wavelength selective film 206 is operable to refract the blue light 107 from the second film surface 116 of the second substrate 104 through the second wavelength selective film 206 and transmit the blue light 107 to the third reflective surface 122 of the third substrate 208. The blue light 107 from the third reflective surface 122 of the third substrate 208 is refracted through the second wavelength selective film 206 and transmitted to the second film surface 116 of the second substrate 104. The wavelength selective film 106 is operable to refract the blue light 107 from the second film surface 116 of the second substrate 104 through the wavelength selective film 106 so that the blue light 107 is transmitted to the structure surface 112 of the first substrate 102.

The second wavelength selective film 206 film described herein is between the second substrate 104 and the third substrate 208 and provides for the reflection of green light 109 having wavelengths with shorter bounce spacing, and diffraction and transmission of blue light 107 having larger bounce spacing. The reflection of green light 109 and the transmission of blue light 107 undergoing TIR through the waveguide combiner 100 provides for a reduced bounce spacing d_{bounce} between the red light 111, blue light 107, and green light 109 at the OCR 134 allowing for a projected image from the OCR 134 with improved color uniformity. The third RI and the third thickness d_{sub3} of the third substrate 208 relative to the second film RI and the second film thickness d_{film2} of the second wavelength selective film 206, the second RI and the second thickness d_{sub2} of the second substrate 104, the film thickness d_{film} and film RI of the wavelength selective film 106, and the first RI and first thickness d_{sub1} of the first substrate 102, as described herein, result in the reduced bounce spacing d_{bounce} to project an image with improved color uniformity.

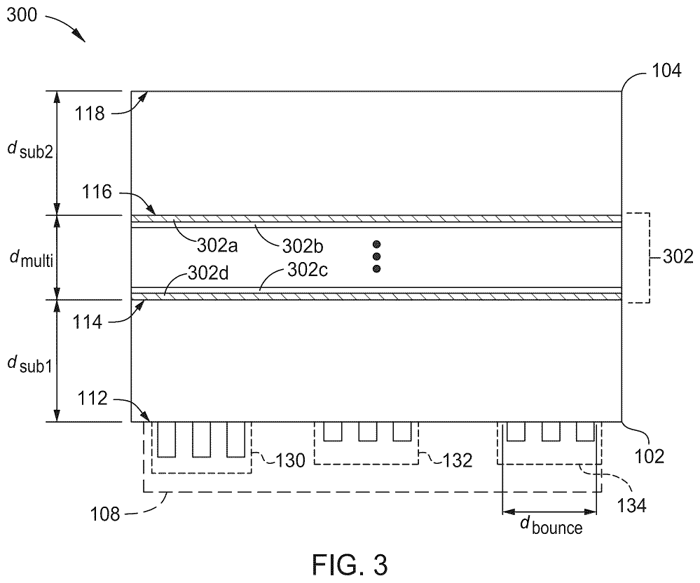

FIG. 3 is a cross sectional view of a waveguide combiner 300 facilitating projection of images with improved color uniformity. The waveguide combiner 300 includes at least one of the first substrate 102, the second substrate 104, and the wavelength selective multilayer film 302. The first substrate 102 includes the structure surface 112 and the first film surface 114 opposing the structure surface 112. The second substrate 104 includes the second film surface 116 and the reflective surface 118 opposing the second film surface 116.

The waveguide combiner 300 includes the SRS 108 disposed on the structure surface 112 of the first substrate 102. The waveguide combiner 300 includes one or more of the ICR 130, the PE 132, or the OCR 134 of the SRS 108.

The wavelength selective multilayer film 302 is disposed between the first film surface 114 and the second film surface 116. In one embodiment, the wavelength selective multilayer film 302 contacts the first film surface 114 and the second film surface 116. The wavelength selective multilayer film 302 has a multilayer film thickness dₘᵤₗₜᵢ from first film surface 114 to the second film surface 116. In some embodiments, the multilayer film thickness dₘᵤₗₜᵢ is greater than about 1 nm to about 10 μm. For example, in some embodiments, the film thickness dₘᵤₗₜᵢ is greater than about 1 nm to about 9 μm, or about 1 nm to about 8 μm, or about 1 nm to about 7 μm, or about 1 nm to about 6 μm, or about 1 nm to about 5 μm, or about 1 nm to about 4 μm, or about 1 nm to about 3 μm, or about 1 nm to about 2 μm, or about 1 nm to about 1 μm, or about 1 nm to about 0.5 μm. In some embodiments, the film thickness dₘᵤₗₜᵢ is greater than about 25 nm to about 4 μm, such as about 50 nm to about 3 μm.

The wavelength selective multilayer film 302 includes at least two sub-layers. For example, the at least two sub-layers could be a sub-layer 302a, sub-layer 302b, sub-layer 302c, and sub-layer 302d. In certain embodiments, the multilayer film 302 includes at least three layers, or at least four layers, or at least five layers, or at least six layers, or at least seven layers, or at least eight layers, or at least nine layers, or at least ten layers, or between ten layers and one hundred layers, or more.

The wavelength selective multilayer film 302 has a multilayer film refractive index. In some embodiments, the wavelength selective multilayer film 302 includes at least two sub-layers, wherein the at least two sub-layers include at least one material with a multilayer film refractive index (RI) of about 1.1, about 1.2, or about 1.3 to less than the first RI at a visible light wavelength. For example, in certain embodiments, the multilayer film RI is about 1.4 to less than the refractive index of the first RI at a visible light wavelength. In other embodiments, the multilayer film refractive index may be the effective refractive index of all of the combined sub-layers, and is about 1.1, about 1.2, about 1.3, or about 1.4 to less than the first refractive index at a visible light wavelength. In yet other embodiments, the multilayer film refractive index is 0.1, about 1.2, about 1.3, or about 1.4 to less than the refractive index of a substrate layer adjacent to the wavelength selective multilayer film 302.

The at least two sub-layers of the wavelength selective multilayer film 302 include, but is not limited to, amorphous dielectrics, non-amorphous dielectrics, crystalline dielectrics, silicon oxides, metals, alloys, polymers, organic resist materials, nanoparticle doped resist materials, optical adhesives or combinations thereof. For example, the at least two sub-layers of the wavelength selective multilayer film 302 may include, but not are not limited to, SiO₂, titanium monoxide (TiO), titanium dioxide (TiO₂), niobium monoxide (NbO), niobium dioxide (NbO₂), niobium pentoxide (Nb₂O₅), hafnium dioxide (HfO₂), tantalum pentoxide (Ta₂O₅), dilanthanum dititanium heptaoxide (La₂Ti₂O₇), aluminum oxide (Al₂O₃), zirconium dioxide (ZrO₂), magnesium difluoride (MgF₂), cerium trifluoride (CeF₃), silicon nitride, or combinations thereof. In some embodiments, the at least two sub-layers of the wavelength selective multilayer film 302 are formed of the same material. In some embodiments the at least two sub-layers of the wavelength selective multilayer film 302 are formed of different materials.

The wavelength selective multilayer film 302 is operable to reflect the red light 111. The red light 111 is reflected from wavelength selective multilayer film 302 to the structure surface 112 of the first substrate 102. The wavelength selective multilayer film 302 is operable to refract the blue light 107 from the structure surface 112 through the wavelength selective multilayer film 302 and further transmit the blue light 107 to the reflective surface 118 of the second substrate 104. The blue light 107 reflecting from the reflective surface 118 of the second substrate 104 is refracted through the wavelength selective multilayer film 302 and transmitted to the structure surface 112 of the first substrate 102. The wavelength selective multilayer film 302 is operable to refract the green light 109 from the structure surface 112 through the wavelength selective multilayer film 302 and further transmit the green light 109 to the reflective surface 118 of the second substrate 104. The green light 109 reflecting from the reflective surface 118 of the second substrate 104 is refracted through the wavelength selective multilayer film 302 and transmitted to the structure surface 112 of the first substrate 102.

The wavelength selective multilayer film 302 described herein provides for reflection of red light 111 having wavelengths with shorter bounce spacing, and diffraction and transmission of blue light 107 and green light 109 having larger bounce spacing. The reflection of red light 111 and the transmission of blue light 107 and green light 109 undergoing TIR through the waveguide combiner 300 provides for a bounce spacing d_{bounce} between the red light 111, blue light 107, and green light 109 at the OCR 134 allowing for a projected image from the OCR 134 with improved color uniformity. The film RI and the film thickness d_{film} of the wavelength selective film 106 relative to the first RI and the first thickness d_{sub1} thickness of the first substrate 102, and the second RI and second thickness d_{sub2} of the second substrate 104 as described herein result in the bounce spacing d_{bounce} to project an image with improved color uniformity.

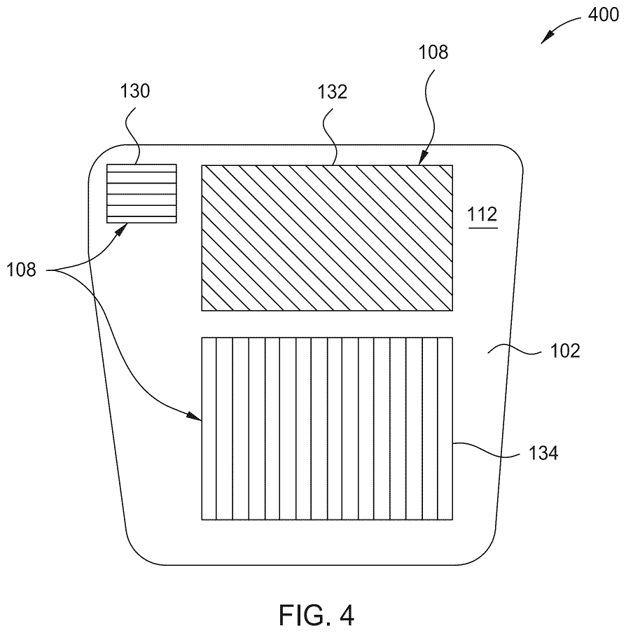

FIG. 4 is a perspective, frontal view of a waveguide combiner 400. It is to be understood that the waveguide combiner 400 is representative of any of the waveguide combiners of FIGS. 1, 2A, 2B, 2C, and 3. The waveguide combiner 400 includes the SRS 108. The SRS 108 may be disposed over, under, or on the structure surface 112 of the first substrate 102, or disposed in the first substrate 102. The SRS 108 are nanostructures and have a sub-micron critical dimension, e.g., a width less than 1 micrometer. Regions or gratings of the SRS 108 correspond to one or more of the ICR 130, PE 132, or OCR 134.

While the foregoing is directed to embodiments of the present disclosure, other and further embodiments of the disclosure may be devised without departing from the basic scope thereof, and the scope thereof is determined by the claims that follow.

What is claimed is:

1. A waveguide combiner, comprising:
a first substrate, the first substrate comprising:
a structure surface and a first film surface opposing the structure surface;
a first refractive index (RI); and
surface relief structures disposed over the structure surface;
a second substrate, comprising:
a second film surface;
a second RI;
a reflective surface opposing the second film surface;
a wavelength selective film between the first film surface and the second film surface, the wavelength selective film having a film RI less than the first RI and the second RI;
the wavelength selective film is operable to:
reflect a red light;
refract a blue light though the wavelength selective film and transmit the blue light to the first substrate and the second substrate; and
refract a green light though the wavelength selective film and transmit the green light to the first substrate and the second substrate.

2. The waveguide combiner of claim 1, wherein the wavelength selective film is operable to:
reflect the red light from the wavelength selective film to the structure surface of the first substrate.

3. The waveguide combiner of claim 2, wherein the wavelength selective film is operable to:
refract the blue light from the structure surface through the wavelength selective film and to the reflective surface of the second substrate, and
refract the blue light reflecting from the reflective surface through the wavelength selective film and to the structure surface of the first substrate.

4. The waveguide combiner of claim 3, wherein the wavelength selective film is operable to:
refract the green light from the structure surface through the wavelength selective film and to the reflective surface of the second substrate, and
refract the green light reflecting from the reflective surface through the wavelength selective film and to the structure surface of the first substrate.

5. The waveguide combiner of claim 4, wherein:
the blue light has a wavelength of about 380 nanometers (nm) to about 495 nm,
the green light has a wavelength of about 495 nm to about 590 nm, and
the red light has a wavelength of about 590 nm to about 750 nm.

6. The waveguide combiner of claim 1, wherein the red light, the blue light, and the green light contact the surface relief structures at an out-coupling region (OCR) of the surface relief structures.

7. The waveguide combiner of claim 1, wherein the first substrate and the second substrate are formed of at least one of a silicon-containing material, a silicon and oxygen containing compound, a germanium-containing material, a indium and phosphide containing compound, a gallium and arsenic containing compound, a gallium and nitrogen containing compound, a carbon-containing material, a silicon and carbon containing compound, a silicon, carbon, and oxygen containing compound, a silicon and nitrogen containing compound, a silicon, oxygen, and nitrogen containing compound, a niobium and oxygen containing compound, and lithium, niobium, and oxygen containing compound, an aluminum and oxygen containing compound, a indium, tin, and oxygen containing compound, a titanium and oxygen containing compound, a lanthanum and oxygen containing compound, a gadolinium and oxygen containing compound, a zinc and oxygen containing compound, a yttrium and oxygen containing compound, a tungsten and oxygen containing compound, a potassium, and oxygen containing compound, a phosphorous and oxygen containing compound, a barium and oxygen containing compound, or a sodium and oxygen containing compound.

8. The waveguide combiner of claim 7, wherein the first substrate and the second substrate are formed of at least one of silicon (Si), silicon monoxide (SiO), silicon dioxide (SiO₂), silicon carbide (SiC), fused silica, diamond, quartz germanium (Ge), silicon germanium (SiGe), indium phosphide (InP), gallium arsenide (GaAs), gallium nitride (GaN), sapphire, sapphire (Al₂O₃), lithium niobate (LiNbO₃), indium tin oxide (ITO), lanthanum oxide (La₂O₃), gadolinium oxide (Gd₂O₅), zinc oxide (ZnO), yttrium oxide (Y₂O₃), tungsten oxide (WO₃), titanium oxide (TiO₂), zirconium oxide (ZrO₃), sodium oxide (Na₂O), niobium oxide (Nb₂O₅), barium oxide (BaO), potassium oxide (K₂O), phosphorus pentoxide (P₂O₅), or calcium oxide (CaO).

9. The waveguide combiner of claim 1, wherein the wavelength selective film is formed of at least one of an amorphous dielectric, non-amorphous dielectric, crystalline dielectric, silicon oxide, metal, alloy, polymer, organic resist material, nanoparticle doped resist material, or optical adhesive.

10. The waveguide combiner of claim 9, wherein the wavelength selective film is formed of at least one of silicon dioxide (SiO₂), titanium monoxide (TiO), titanium dioxide (TiO₂), niobium monoxide (NbO), niobium dioxide (NbO₂), niobium pentoxide (Nb₂O₅), hafnium dioxide (HfO₂), tantalum pentoxide (Ta₂O₅), dilanthanum dititanium heptaoxide (La₂Ti₂O₇), aluminum oxide (Al₂O₃), zirconium dioxide (ZrO₂), magnesium difluoride (MgF₂), cerium trifluoride (CeF₃), or silicon nitride (Si₃N₄).

11. A waveguide combiner, comprising:
a first substrate, the first substrate comprising:
a structure surface;
a first film surface opposing the structure surface; and
surface relief structures disposed over the structure surface;
a second substrate, comprising:
a second film surface; and
a reflective surface opposing the second film surface;
a wavelength selective film between the first film surface and the second film surface; and
a local thickness adjustment layer (LTAL) disposed over the reflective surface, the LTAL having a target substrate thickness distribution varying over the reflective surface.

12. The waveguide combiner of claim 11, wherein the surface relief structures are organized into at least one of an out-coupling region (OCR), an in-coupling region (ICR) and a pupil expander (PE).

13. The waveguide combiner of claim 11, wherein the wavelength selective film contacts the first film surface and the second film surface.

14. The waveguide combiner of claim 11, wherein the LTAL contacts the reflective surface.

15. The waveguide combiner of claim 11, wherein the first substrate and the second substrate are formed of at least one of silicon (Si), silicon monoxide (SiO), silicon dioxide (SiO₂), silicon carbide (SiC), fused silica, diamond, quartz germanium (Ge), silicon germanium (SiGe), indium phosphide (InP), gallium arsenide (GaAs), gallium nitride (GaN), sapphire, sapphire (Al₂O₃), lithium niobate (LiNbO₃), indium tin oxide (ITO), lanthanum oxide (La₂O₃), gadolinium oxide (Gd₂O₅), zinc oxide (ZnO), yttrium oxide (Y₂O₃), tungsten oxide (WO₃), titanium oxide (TiO₂), zirconium oxide (ZrO₃), sodium oxide (Na₂O), niobium oxide (Nb₂O₅), barium oxide (BaO), potassium oxide (K₂O), phosphorus pentoxide (P₂O₅), or calcium oxide (CaO).

16. The waveguide combiner of claim 11, wherein the wavelength selective film is formed of at least one of silicon dioxide (SiO₂), titanium monoxide (TiO), titanium dioxide (TiO₂), niobium monoxide (NbO), niobium dioxide (NbO₂), niobium pentoxide (Nb₂O₅), hafnium dioxide (HfO₂), tantalum pentoxide (Ta₂O₅), dilanthanum dititanium heptaoxide (La₂Ti₂O₇), aluminum oxide (Al₂O₃), zirconium dioxide (ZrO₂), magnesium difluoride (MgF₂), cerium trifluoride (CeF₃), or silicon nitride (Si₃N₄).

17. The waveguide combiner of claim 11, wherein the LTAL is formed of at least one of silicon (Si), silicon dioxide (SiO2), fused silica, quartz, silicon carbide (SiC), germanium (Ge), silicon germanium (SiGe), indium phosphide (InP), gallium arsenide (GaAs), gallium nitride (GaN), sapphire, or combinations thereof.

18. The waveguide combiner of claim 11, further comprising an anti-reflection coating disposed over the reflective surface.

19. The waveguide combiner of claim 17, wherein the anti-reflection coating is formed of at least one of silicon dioxide (SiO₂), titanium monoxide (TiO), titanium dioxide (TiO₂), niobium monoxide (NbO), niobium dioxide (NbO₂), niobium pentoxide (Nb₂O₅), hafnium dioxide (HfO₂), tantalum pentoxide (Ta₂O₅), dilanthanum dititanium heptaoxide (La₂Ti₂O₇), aluminum oxide (Al₂O₃), zirconium dioxide (ZrO₂), magnesium difluoride (MgF₂), cerium trifluoride (CeF₃), or silicon nitride (Si₃N₄).

20. A method of projecting an image with improved color uniformity, comprising:
incoupling a light to a waveguide combiner, wherein:
the light comprises at least three input wavelengths, the at least three input wavelengths comprising a blue light, a green light, and a red light; and
the waveguide combiner comprises:
a structure surface;
a first substrate;
a second substrate comprising a reflective surface; and
a wavelength selective film disposed between the first substrate and the second substrate;
reflecting the red light with the wavelength selective film to the structure surface;
refracting the blue light though the wavelength selective film and transmitting the blue light to the first substrate and the second substrate;
refracting green light though the wavelength selective film and transmitting the green light to the first substrate and the second substrate; and
outcoupling the light from the waveguide combiner.
